(19) United States
(12) Patent Application Publication
(10) Pub. No.: US 2009/0096301 A1
(43) Pub. Date: Apr. 16, 2009

(54) Motor drive circuit mounting structure and electric compressor

(75) Inventors: Tomoyuki Sumi, Kariya-city (JP); Tatsuhiro Matsuki, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/285,800

(22) Filed: Oct. 14, 2008

(30) Foreign Application Priority Data
Oct. 16, 2007 (JP) 2007-268766
May 26, 2008 (JP) 2008-136398

(51) Int. Cl. H02K 5/00

(52) U.S. Cl. 310/89

(57) ABSTRACT

A mounting structure of a motor drive circuit and an electric compressor are disclosed. A sub-communication circuit 50a of a communication circuit 50 is accommodated in a depression 11v of a compressor housing 11. Semiconductor switching devices S1 to S6 are arranged on the flat mounting portion 11t of the compressor housing 11, i.e. on the outside of the depression 11v. As a result, the sub-communication circuit 50a can be isolated from the semiconductor switching devices S1 to S6. Although the switching operation of the semiconductor switching devices S1, S2, . . . , S6 generates electromagnetic noise, since the sub-communication circuit 50a is accommodated in the depression 11v, the sub-communication circuit 50a receives less electromagnetic noise.

### BACKGROUND OF THE INVENTION

1. Field of the Invention

This invention relates to a mounting structure of a motor drive circuit and an electric compressor.

2. Description of the Related Art

A conventional electric compressor is configured of a compression unit accommodated in a housing, a three-phase AC motor accommodated in the housing to drive the compression unit and a motor drive circuit mounted on the outer wall of the housing to drive the three-phase AC motor (refer to, for example, Japanese Unexamined Patent Publication No. 2003-262187).

Generally, the motor drive circuit of an electric compressor includes a high-voltage circuit having six semiconductor switching devices inserted between two power terminals of a high-voltage power supply and a low-voltage circuit supplied with power from the a low-voltage power supply to drive each semiconductor switching device.

With each semiconductor switching device controlled by the low-voltage circuit, the high-voltage circuit outputs a three-phase AC voltage to an three-phase AC motor based on the switching operation of each semiconductor switching device. As a result, the motor drive circuit can drive a three-phase AC motor.

### SUMMARY OF THE INVENTION

In the electric compressor described above, electromagnetic noise is generated by the switching operation of each semiconductor switching device. The low-voltage circuit may be adversely affected by the electromagnetic noise generated from each semiconductor switching device.

To cope with this problem, a shield plate, for example, may be used to shield the low-voltage circuit from the electromagnetic wave at the sacrifice of an increased number of parts and a higher cost.

In view of this situation, the object of this invention is to provide a mounting structure of a motor drive circuit and an electric compressor for preventing the low-voltage circuit from being adversely affected by electromagnetic noises without using the shield plate.

In order to achieve this object, according to a first aspect of this invention, there is provided a motor drive circuit comprising:

a high-voltage circuit (52) having switching devices adapted to output, by the switching operation thereof, the drive voltage for the electric motor based on the output voltage of a high-voltage power supply (61); and

a low-voltage circuit (50, 51) supplied with power from a low-voltage power supply (60) for outputting a source voltage lower than the output voltage of the high-voltage power supply thereby to cause the switching devices to perform the switching operation;

wherein a depression (11v) is formed on a solid portion of the housing; and

wherein the low-voltage circuit (50a) is arranged in the depression while the switching devices are arranged outside the depression.

In this configuration, at least a part of the low-voltage circuit is arranged in the depression, and the switching devices outside the depression. Electromagnetic noise does not easily transmit through the metal housing. Even in the case where the electromagnetic noise is generated by the switching devices, therefore the part of the low-voltage circuit can be isolated from the electromagnetic noise. Thus, the low-voltage circuit is not easily affected by the electromagnetic noise generated by the switching devices.

According to a second aspect of the invention, there is provided a mounting structure of the motor drive circuit, wherein the low-voltage circuit includes a communication circuit (50) for conducting communication with an external device and a control circuit (51) for outputting a control signal to control the switching operation of the switching devices based on the communication between the external device and the communication circuit, wherein the communication circuit is arranged in the depression.

As a result, the communication circuit is not easily affected by the electromagnetic noise, and satisfactory communication is established.

According to a third aspect of the invention, there is provided a mounting structure of the motor drive circuit,

wherein the speed of the electric motor is changed with the drive voltage output from the high-voltage circuit,

wherein the rotational speed information indicating the speed of the electric motor is detected by a sensor (301),

wherein the low-voltage circuit includes a control circuit (51) for operating the switching devices in such a manner that the drive voltage for attaining the actual speed of the electric motor in proximity to the target speed of the electric motor is output from the high-voltage circuit based on the detection value of the sensor, and

wherein the control circuit is arranged in the depression.

According to a fourth aspect of the invention, there is provided a mounting structure of the motor drive circuit,

wherein the control circuit includes a signal processing circuit (51a) for processing the output signal of the sensor and an arithmetic circuit (51b) for outputting a control signal to control the switching operation of the switching devices based on the output signal of the signal processing circuit;

wherein one of the signal processing circuit and the arithmetic circuit is arranged in the depression.

According to a fifth aspect of the invention, there is provided a mounting structure of the motor drive circuit,

wherein the housing is formed substantially in the shape of a cylinder,

wherein the outer wall of the housing has a first surface (11t) formed in superposition with the longitudinal axis of the housing and the switching devices are mounted the first surface, and

wherein the depression formed on the solid portion of the housing is located lateral to the first surface.

The thickness (designated by ta in FIG. 6) of the solid portion of the substantially cylindrical housing (11) increases in the orthogonal direction from the center of the flat surface. Like in the aforementioned invention, therefore the depression, if located lateral to the flat surface of the solid portion of the housing, can be formed without increasing the housing body.

The term “orthogonal direction” is defined as the direction at right angles to the longitudinal axis of the substantially cylindrical housing.

According to a sixth aspect of the invention, there is provided a mounting structure of the motor drive circuit,

wherein the electric motor includes a rotary shaft (310a) arranged in the hollow portion of the housing in such a manner as to extend in the direction of the longitudinal axis of the housing, a rotor (310) arranged in the hollow portion of the housing to rotate the rotary shaft based on a rotating magnetic field, and a stator (320) arranged radially outward in relation to the rotor in the hollow portion of the housing to generate the rotating magnetic field based on the output voltage of the high-voltage circuit, and

wherein the depression formed on the solid portion of the housing is located on one side of the stator in the axial direction.

According to a seventh aspect of the invention, there is provided a mounting structure of the motor drive circuit,

wherein the housing is formed in the shape of a cylinder, and

wherein the depression formed on the solid portion of the housing is located along the longitudinal axis of the housing.

According to an eighth aspect of the invention, there is provided a mounting structure of the motor drive circuit,

wherein the outer wall of the housing has a second surface (11r, 11q) crossing the first surface (11t), and

wherein the depression is formed at the corner of the first and second surfaces in such a manner as to be depressed from the first surface side and the second surface side.

According to a ninth aspect of the invention, there is provided a mounting structure of the motor drive circuit,

wherein the housing includes a refrigerant inlet (11c) and a refrigerant outlet (11d);

wherein the refrigerant is sucked in through the refrigerant inlet and compressed by a compression unit (400) arranged in the hollow portion of the housing and a high-pressure refrigerant is discharged from the refrigerant outlet; and

wherein the electric motor drives the compression unit.

According to a tenth aspect of the invention, there is provided an electric compressor, comprising:

a metal housing (11) having a refrigerant inlet (11c) and a refrigerant outlet (11d);

a compression unit (400) arranged in a hollow portion of the housing for sucking in the refrigerant through the refrigerant inlet, compressing it and discharging the high-pressure refrigerant from the refrigerant outlet;

an electric motor (300) arranged in the hollow portion of the housing to drive the compression unit; and

a motor drive circuit (210) for driving the electric motor, the motor drive circuit being mounted on the outside of the housing and including:

a high-voltage circuit (52) having switching devices adapted to output, by a switching operation thereof, the drive voltage for the electric motor based on the output voltage of a high-voltage power supply (61); and

a low-voltage circuit (50, 51) supplied with power from a low-voltage power supply to cause the switching devices to perform a switching operation;

wherein an open depression (11v) is formed on a solid portion of the housing, and at least a part of the low-voltage circuit is arranged in the depression, while the switching devices are arranged outside the depression.

Thus, at least a part of the low-voltage circuit is arranged in the depression, while the switching devices are arranged outside the depression. In addition, the electromagnetic wave noise cannot be easily transmitted through the metal housing. Thus, a similar effect to the invention described above can be obtained.

The reference numeral inserted in the parenthesis following the name of each means described in the claims and this section indicates the correspondence with the specific means described later in the embodiments.

The present invention may be more fully understood from the description of preferred embodiments of the invention, as set forth below, together with the accompanying drawings.

### BRIEF DESCRIPTION OF THE DRAWINGS

FIG. 1 is a perspective view of an automotive electric compressor according to a first embodiment of the invention.

FIG. 2 is a top plan view of the automotive electric compressor according to the first embodiment.

FIG. 3 is a front view of the automotive electric compressor according to the first embodiment.

FIG. 4 is a left side view of the automotive electric compressor according to the first embodiment.

FIG. 5 is a partial sectional view showing the interior of the hollow portion of the compressor housing according to the first embodiment.

FIG. 6 is a sectional view taken along line A-A in FIG. 2 of the first embodiment.

FIG. 7 is a top plan view of the compressor housing according to the first embodiment.

FIG. 8 is a diagram showing an electric circuit configuration of the motor drive circuit according to the first embodiment.

FIG. 9 is a perspective view showing the compressor housing according to the first embodiment.

FIG. 10 is a sectional view of the automotive electric compressor according to a second embodiment of the invention.

FIG. 11 is a sectional view of the automotive electric compressor according to a third embodiment of the invention.

FIG. 12 is a top plan view of the automotive electric compressor according to the third embodiment.

FIG. 13 is a sectional view of an automotive electric compressor according to a fourth embodiment of the invention.

FIG. 14 is a sectional view taken along line B-B in FIG. 13.

FIG. 15 is an electrical circuit diagram showing the motor drive circuit of FIG. 8 according a modification.

### DESCRIPTION OF THE PREFERRED EMBODIMENTS

### First Embodiment

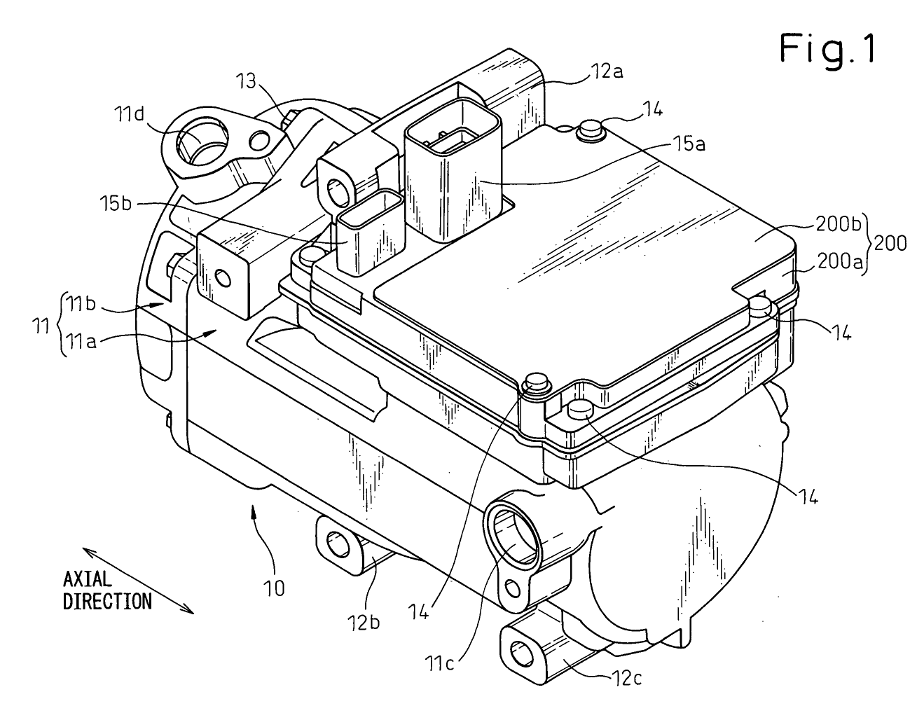

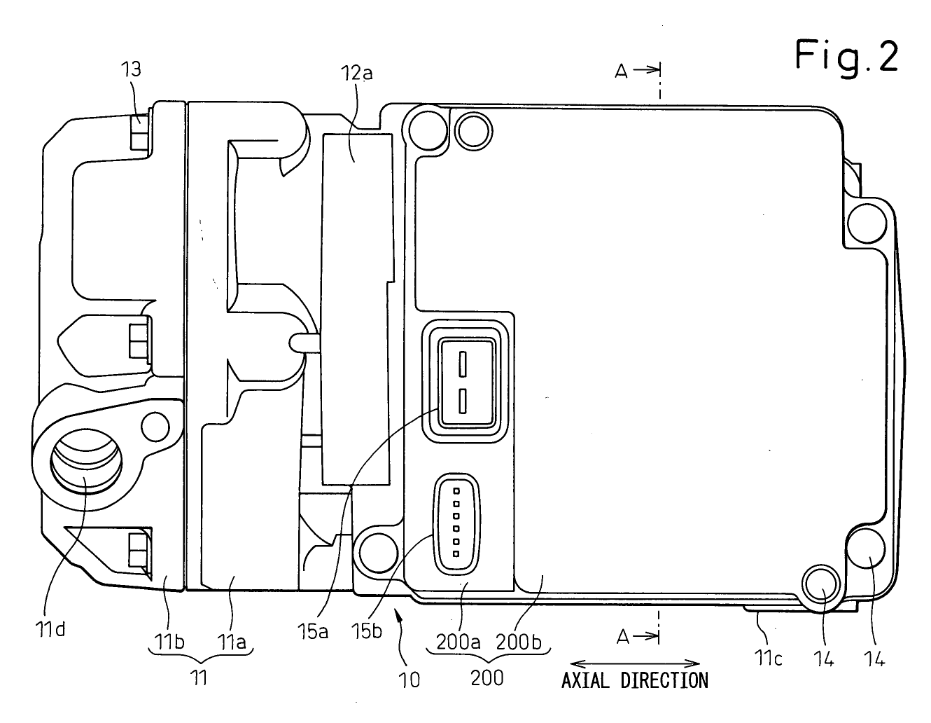

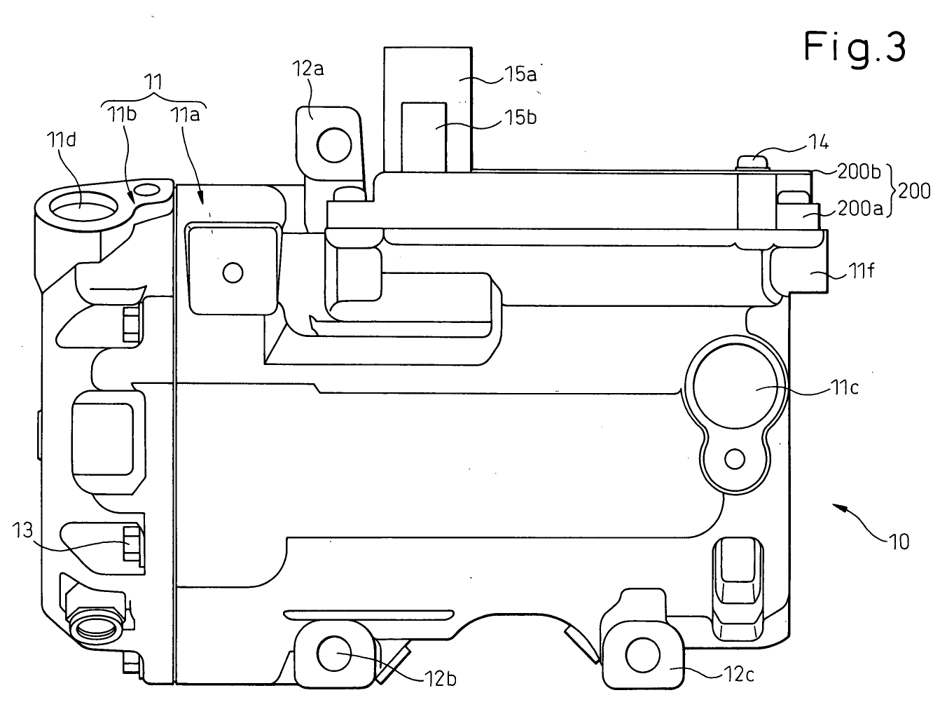

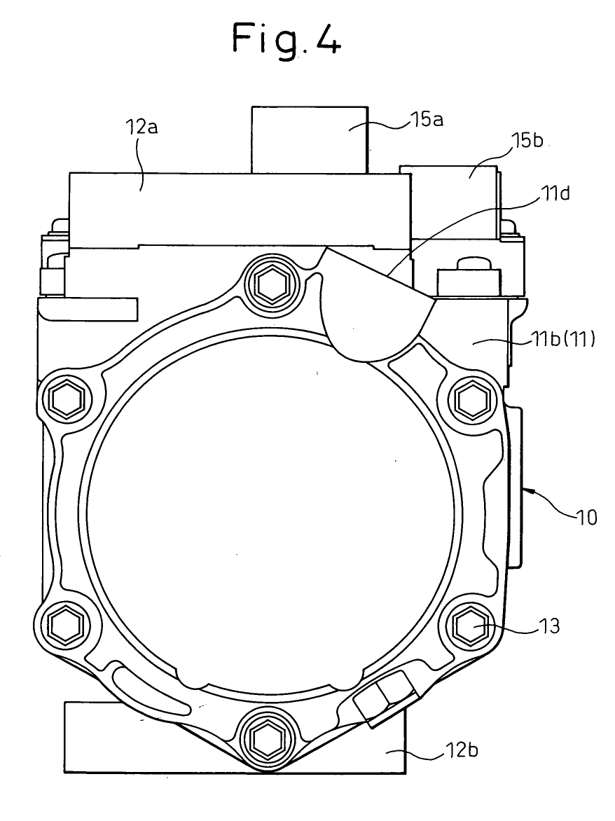

The electric compressor for automobiles according to the first embodiment of the invention is shown in FIGS. 1 to 3. FIG. 1 is a perspective view of the automotive electric compressor, FIG. 2 a top plan view of the automotive electric compressor, FIG. 3 a front view of the automotive electric compressor, and FIG. 4 is a left side view of the automotive electric compressor.

The automotive electric compressor 10 according to this embodiment, as shown in FIG. 1, together with a condenser, an expansion valve and an evaporator, makes up a well-known refrigeration cycle system for circulating the refrigerant of the automotive air conditioning system.

The automotive electric compressor 10, as shown in FIG. 1, has a compressor housing 11. The compressor housing 11 is configured of a cylindrical housing body 11a and a lid portion 11b. The cylindrical housing body 11a is formed with an opening exposed to a first axial end, and the lid portion 11b is coupled to the cylindrical housing body 11a with bolts to close the opening.

The second axial end of the cylindrical housing body 11a is formed with a refrigerant inlet 11c, and the lid portion 11b has a refrigerant outlet 11d.

The compressor housing 11, as shown in FIG. 3, has mounting legs 12a, 12b and 12c. The mounting leg 12a is arranged on the upper left wall portion of the compressor housing 11 in FIG. 3. The mounting leg 12a is formed as a prism projected upward in FIG. 3 and extending linearly in an orthogonal direction T orthogonal to the axial direction of the compressor housing 11. The mounting leg 12a is formed with a through hole in which a bolt (not shown) is inserted in the orthogonal direction T.

The mounting legs 12b and 12c, like the mounting leg 12a, are each formed as a prism extending in the orthogonal direction T. The mounting leg 12b is arranged on the lower right wall portion, shown in FIG. 3, of the compressor housing 11, and the mounting leg 12c on the lower left wall portion, shown in FIG. 3, of the compressor housing 11.

The mounting legs 12b and 12c, like the mounting leg 12a, each have a through hole. Bolts (not shown) are used to fix the compressor housing 11 on the side wall of the vehicle engine.

The compressor housing 11 and the mounting legs 12a, 12b and 12c are integrally formed of a metal material such as aluminum through which the electromagnetic wave is hardly passed. Nevertheless, the compressor housing 11 and the mounting legs 12a, 12b and 12c may be formed of any other material than aluminum through which the electromagnetic wave is hard to pass.

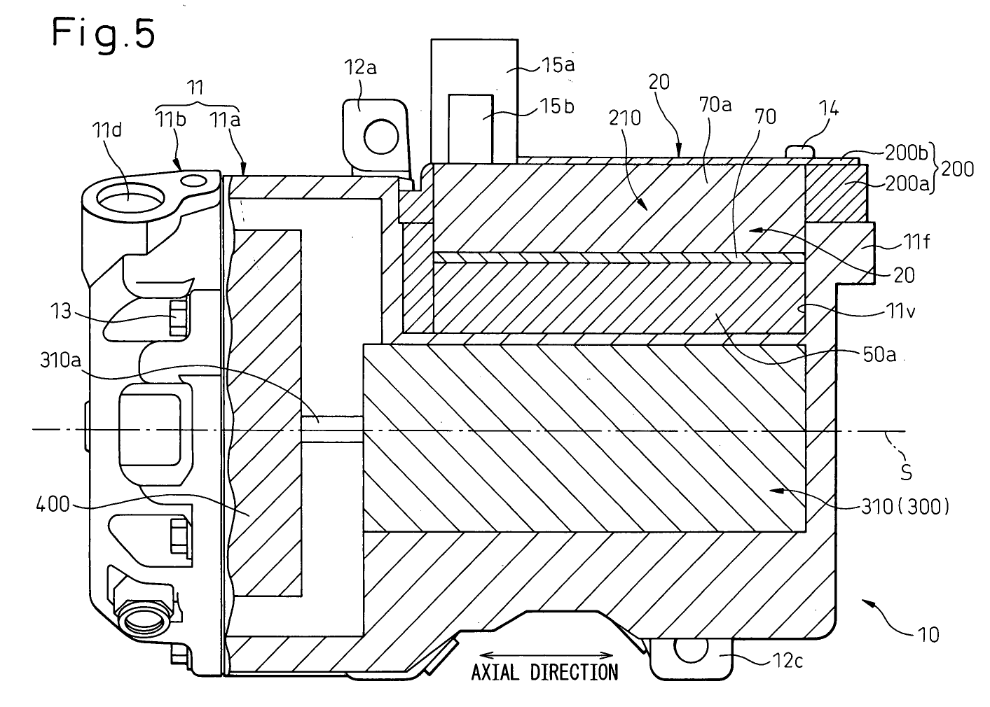

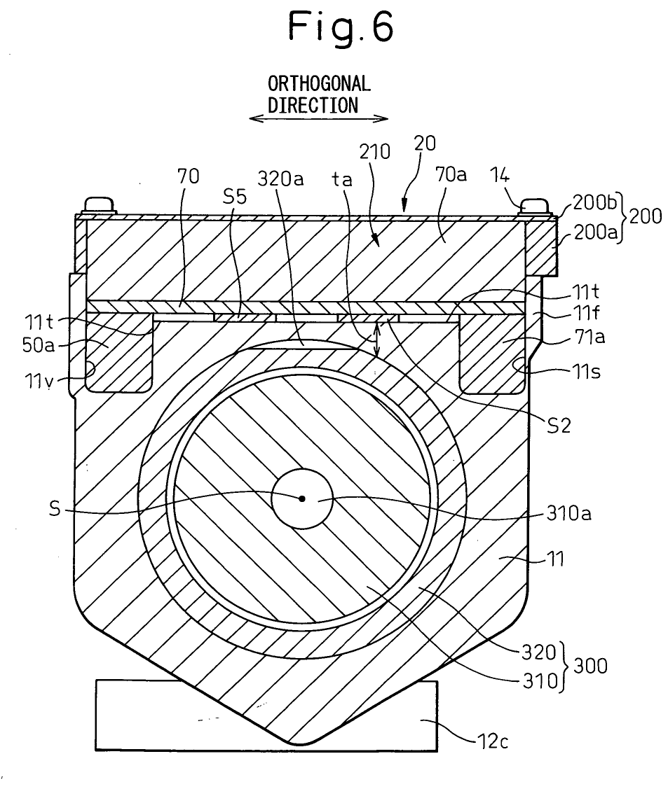

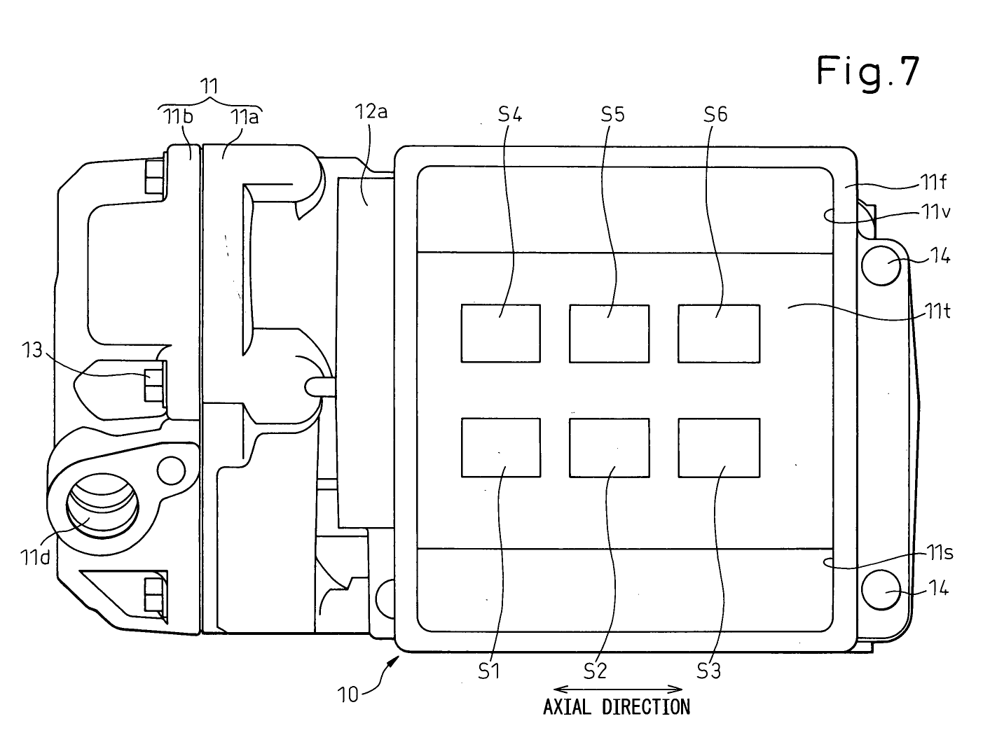

FIG. 5 is a partial sectional view showing the interior of the hollow portion of the compressor housing 11, and FIG. 6 a sectional view taken along line A-A in FIG. 2. FIG. 7 is a top plan view of the compressor housing 11.

The part of the upper outer wall of the compressor housing 11 on the right of the mounting leg 12a in FIG. 5 has a flat mounting portion 11t. The flat mounting portion 11t, which corresponds to the first surface described in the appended claims, is arranged so that the longitudinal axis S of the compressor housing 11 is superimposed thereon.

Depressions 11s and 11v are formed on the opposed sides of the flat mounting portion 11t, in the orthogonal direction, of the solid portion of the compressor housing 11. The depressions 11s and 11v are each formed as a parallelepiped depressed from the flat mounting portion 11t, open outward and extended in the axial direction. The depression 11v corresponds to the depression described in the appended claims.

The compressor housing 11 has an encompassing wall potion 11f formed in such a manner as to surround the flat mounting portion 11t and the depressions 11s and 11v. A motor drive circuit described later is mounted inside the encompassing wall portion 11f.

The electric motor 300 and the compression unit 400 are arranged in the hollow portion of the compressor housing 11. The electric motor 300 is arranged in the second axial end side (right side in FIG. 5). The electric motor 300 is a synchronous three-phase motor and includes a rotor 310 and a stator 320.

The rotor 310 is a cylindrical permanent magnet, and a rotary shaft 310 is passed through the hollow portion of the rotor 310. The rotary shaft 310a is fixed on the rotor 310. The rotary shaft 310a is arranged to extend along the longitudinal axis of the compressor housing 11. Specifically, the axial direction of the rotary shaft 310a coincides with that of the compressor housing 11. The rotary shaft 310a is supported rotatably on bearings (not shown).

The stator 320 is arranged radially outward in relation to the rotor 310. The stator 320 is fixed on the inner peripheral surface of the compressor housing 11. The stator 320 has a stator coil wound on the stator core.

The stator coil is configured of the U-phase coil, the V-phase coil and the W-phase coil and generates a rotating magnetic field based on the three-phase AC voltage (drive voltage) output from the motor drive unit 20.

As shown in FIG. 6, a refrigerant path 320a for supplying the refrigerant in axial direction is formed on the flat mounting portion 11t side of the hollow portion of the compressor housing 11. The refrigerant path 320a is formed between the outer peripheral surface of the stator 320 and the inner peripheral surface of the compressor housing 11.

The motor drive unit 20 makes up a motor drive unit for driving the electric motor 300. The motor drive unit 20 includes a motor drive housing 200 and a motor drive circuit 210.

The motor drive housing 200 is configured of a housing body 200a and a lid portion 200b for closing the opening of the housing body 200a. The housing body 200a is arranged on the encompassing wall portion 11f. The housing body 200a and the lid portion 200b, together with the encompassing wall portion 11f, define the space for accommodating the motor drive circuit 210.

The housing body 200a is fastened with screws 14 to the compressor housing 11. On the other hand, the lid portion 200b is fastened with the screws 14 to the housing body 200a. The housing body 200a and the lid portion 200b are formed of a metal material such as aluminum.

The compression unit 400 is arranged in the first axial end side. The compression unit 400 is a well-known scroll compressor configured of a fixed scroll unit and a movable scroll unit. The movable scroll unit is driven by the electric motor 300 to revolve around the fixed scroll unit, so that the refrigerant is introduced, compressed and discharged.

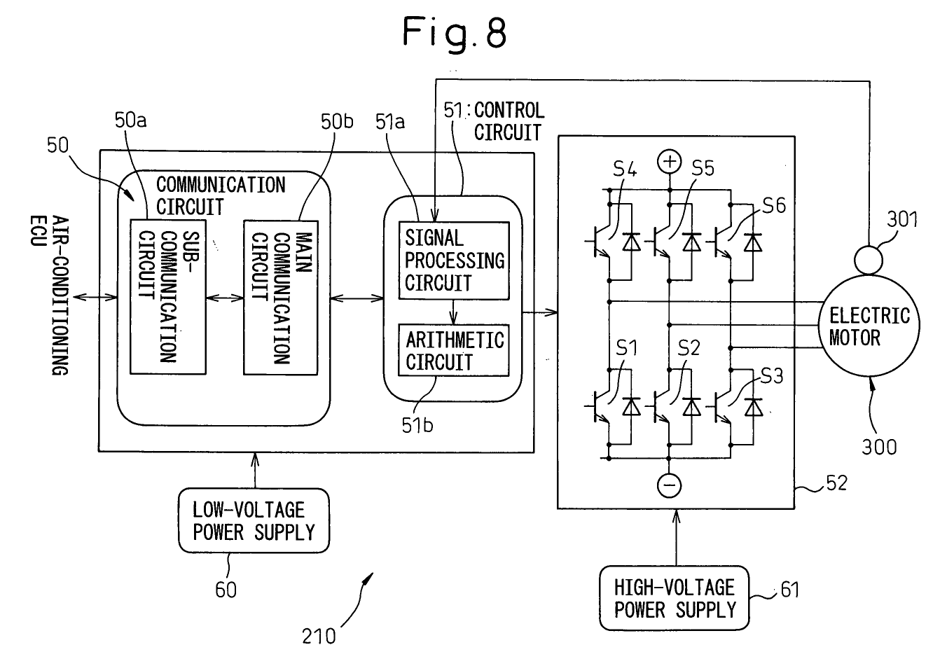

Next, the configuration of the electrical circuit of the motor drive circuit 210 according to this embodiment will be explained with reference to FIG. 8.

The motor drive circuit 210 includes a communication circuit 50, a control circuit 51 and a switching circuit 52.

The communication circuit 50 and the control circuit 51 make up a low-voltage circuit operated by the power supplied from the low-voltage power supply 60. The switching circuit 52 makes a high-voltage circuit operated by the power supplied from the high-voltage power supply 61.

The low-voltage power supply 60 and the high-voltage power supply 61 each comprises, for example, a battery. The source voltage output from the low-voltage power supply 60 is set to a lower level than the source voltage output from the high-voltage power supply 61.

The switching circuit 52 includes semiconductor switching devices S1, S2, . . . , S6.

The semiconductor switching devices S1, S2, . . . , S6, each of which is, for example, a bipolar transistor of insulated gate type, constitute a well-known inverter circuit which is composed of three pairs of series semiconductor switching devices connected in parallel to each other between the positive terminal (+) and the negative terminal (−) of the high-voltage power supply 61.

The inverter circuit with the semiconductor switching devices S1, S2, . . . , S6 outputs, to the stator coil of the electric motor 300, the drive voltage constituting the three-phase AC voltage based on the output voltage of the high-voltage power supply 61.

The communication circuit 50 is a circuit device for conducting the communication in the passenger compartment with an air-conditioning ECU (external device). The communication circuit 50 includes a sub-communication circuit 50a and a main communication circuit 50b. The sub-communication circuit 50a is an interface circuit for carrying out the communication protocol conversion and the frequency conversion.

The main communication circuit 50b conducts the communication in the passenger compartment with the air-conditioning ECU through the sub-communication circuit 50a. As a result, the main communication circuit 50b receives the target speed of the electric motor 300 from the air-conditioning ECU.

The CAN, LIN or SCI scheme, for example, may be used as the communication protocol for the communication with the ECU in the passenger compartment.

The control circuit 51 includes a signal processing circuit 51a and an arithmetic circuit 51b. The signal processing circuit 51a processes the output signal of the rotation sensor 301 by, for example, a waveform shaping. The rotation sensor 301 is for detecting the actual speed of the electric motor 300. According to this embodiment, a Hall device is used to detect the magnetic fluxes (i.e. the rotating magnetic field) leaking from the electric motor 300 as the rotational speed information indicating the speed of the electric motor 300.

The arithmetic circuit 51b, based on the output signal of the signal processing circuit 51a, performs the control operation by outputting the control signal of the semiconductor switching devices S1, S2, . . . , S6 according to the PWM scheme.

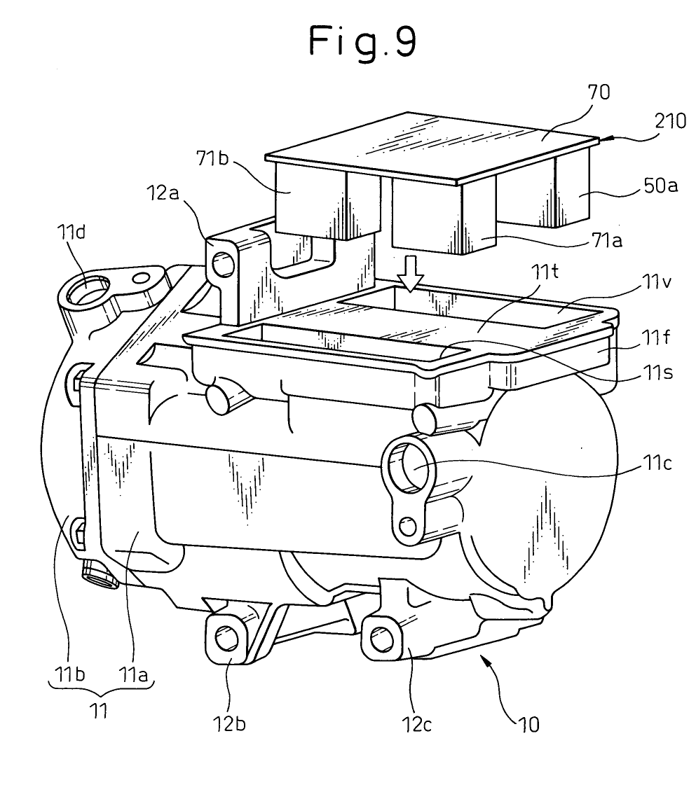

Next, the mounting structure of the motor drive circuit 210 according to this embodiment will be explained with reference to FIG. 9.

FIG. 9 is a perspective view showing the state before the motor drive unit 20 is mounted and thus the motor drive housing 200 is removed from the compressor housing 11.

The motor drive circuit 210 has a circuit board 70 arranged substantially in parallel to the flat mounting portion 11t.

The circuit board 70 has mounted thereon the communication circuit 50, the control circuit 51 and the switching circuit 52 (other than the semiconductor switching devices S1 to S6). The reference numeral 70a in FIGS. 5 and 6 designates the mounted parts of the circuits 50, 51 and 52 other than the semiconductor switching devices S1 to S6.

The semiconductor switching devices S1 to S6, as shown in FIG. 7, are arranged on the flat mounting portion 11t. The semiconductor switching devices S1 to S6, as shown in FIG. 6 (in which only the semiconductor switching devices S2 and S5 are shown), are arranged between the circuit board 70 and the flat mounting portion 11t.

The sub-communication circuit 50a is mounted on the back surface of the circuit board 70 at one end thereof in the orthogonal direction. An electromagnetic coil 71a and a capacitor 71b are mounted on the back surface of the circuit board 70 at the other end thereof in the orthogonal direction. The electromagnetic coil 71a and the capacitor 71b make up a filter circuit connected between the switching circuit 52 and the high-voltage power supply 61 to shape the waveform of the input voltage of the switching circuit 52.

The sub-communication circuit 50a is accommodated in the depression 11v. The electromagnetic coil 71a and the capacitor 71b are accommodated in the depression 11s. The circuit board 70 is arranged in such a manner as to hold the semiconductor switching devices S1 to S6 with the flat mounting portion 11t.

The circuit board 70 is held between the motor drive housing 200 and the flat mounting portion 11t.

Next, the operation of the electric compressor 10 for automobiles according to this invention will be explained.

First, the communication circuit 50 of the motor drive unit 20 receives the target speed by the communication in the passenger compartment with the air-conditioning ECU.

Then, the arithmetic circuit 51b, based on the output signal of the signal processing circuit 51a, outputs to the semiconductor switching devices S1, S2, . . . , S6 a control signal for securing the actual speed of the electric motor 300 approximate to the target speed.

Then, the semiconductor switching devices S1, S2, . . . , S6 operate to output the three-phase AC voltage to the stator 320, which in turn generates a rotating magnetic field. The rotor 30 rotates with the rotary shaft 310a due to the rotating magnetic field. Then, the movable scroll unit scrolls with respect to the fixed scroll unit.

The low-temperature low-pressure refrigerant from the refrigerant outlet of the evaporator is sucked in through the refrigerant inlet 11c. The low-temperature low-pressure refrigerant thus sucked in flows along the axial direction in the refrigerant path 320a. The low-temperature low-pressure refrigerant that has passed through the refrigerant path 320a is compressed into a high-temperature high-pressure refrigerant by the fixed scroll and the movable scroll. The high-temperature high-pressure refrigerant is discharged into the refrigerant inlet of the condenser from the refrigerant outlet 11d.

The low-temperature low-pressure refrigerant, while flowing through the refrigerant path 320a, can cool the semiconductor switching devices S1, S2, . . . , S6 via the compressor housing 11.

According to the embodiment described above, the sub-communication circuit 50a is accommodated in the depression 11s. The semiconductor switching devices S1 to S6 are arranged on the flat mounting portion 11t, i.e. on outside the depression 11v. The operation of the semiconductor switching devices S1, S2, . . . , S6 generates an electromagnetic noise.

However, since the compressor housing 11 is formed of aluminum (metal), the electromagnetic noise is not easily transmitted. Further, the sub-communication circuit 50a, which is accommodated in the depression 11s, can be isolated from the electromagnetic noise generated by the semiconductor switching devices S1 to S6. Therefore, the sub-communication circuit 50a is not easily affected by the electromagnetic noise.

According to this embodiment, the electromagnetic coil 71a and the capacitor 71b are accommodated in the depression 11s, and therefore can be mounted on the circuit board 70 without increasing the body size of the compressor housing 11.

According to this embodiment, the flat mounting portion 11t is arranged in such a manner as to cover the longitudinal axis S on the upper outer wall of the compressor housing 11. The opposed sides of the solid portion of the compressor housing 11, in the orthogonal direction, of the flat mounting portion 11t are formed with the depressions 11s and 11v.

The thickness (designated by ta in FIG. 6) of the solid portion of the substantially cylindrical compressor housing 11 increases in the orthogonal direction from the center of the flat mounting portion. According to this embodiment, the depressions 11s and 11v are formed in the solid portion of the compressor housing 11 on the opposed sides, in the orthogonal direction, of the flat mounting portion 11t without increasing the body size of the compressor housing 11.

An increased body size of the compressor housing 11 would make it inconvenient to mount the automotive electric compressor 10 on the vehicle.

However, according to this embodiment the electromagnetic coil 71a and the capacitor 71b can be mounted on the circuit board 70 with the depressions 11s, 11b without increasing the body size of the compressor housing 11. As a result, the automotive electric compressor 10 can be mounted satisfactorily on the vehicle.

### Second Embodiment

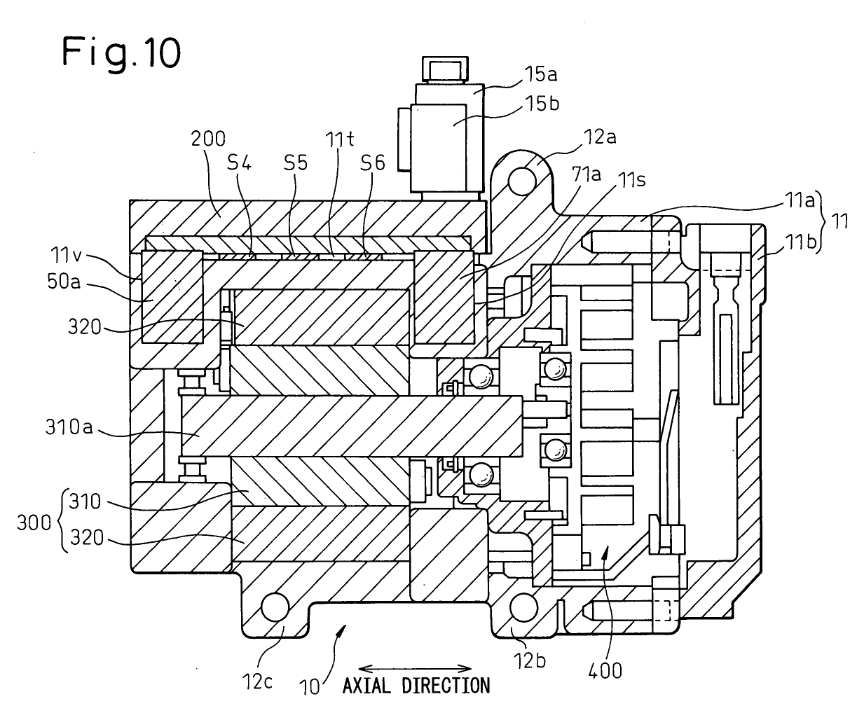

The first embodiment described above refers to a case in which the depressions 11s and 11v are formed on the opposed sides of the flat mounting portion 11t in the orthogonal direction. On the other hand, according to the second embodiment, as shown in the sectional view of FIG. 10, the depressions 11s and 11v are formed on the opposed sides of the flat mounting portion 11t in the axial direction. Specifically, the depressions 11s and 11v are formed on the two axial sides of the stator 320 included in the solid portion of the compressor housing

As a result, the electromagnetic coil 71a and the capacitor 71b are arranged at the first axial end of the stator 320, while the sub-communication circuit 50a is arranged at the second axial end of the stator 320.

### Third Embodiment

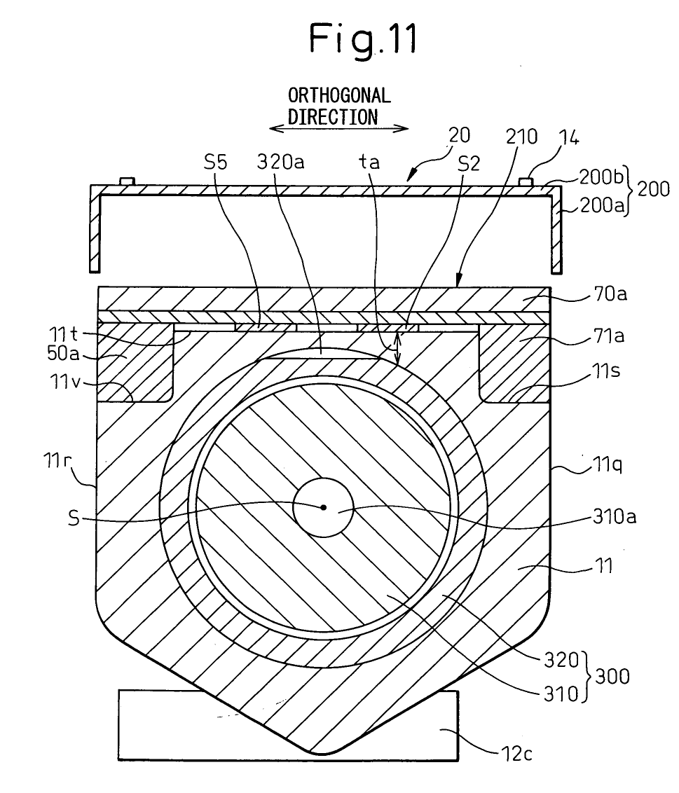

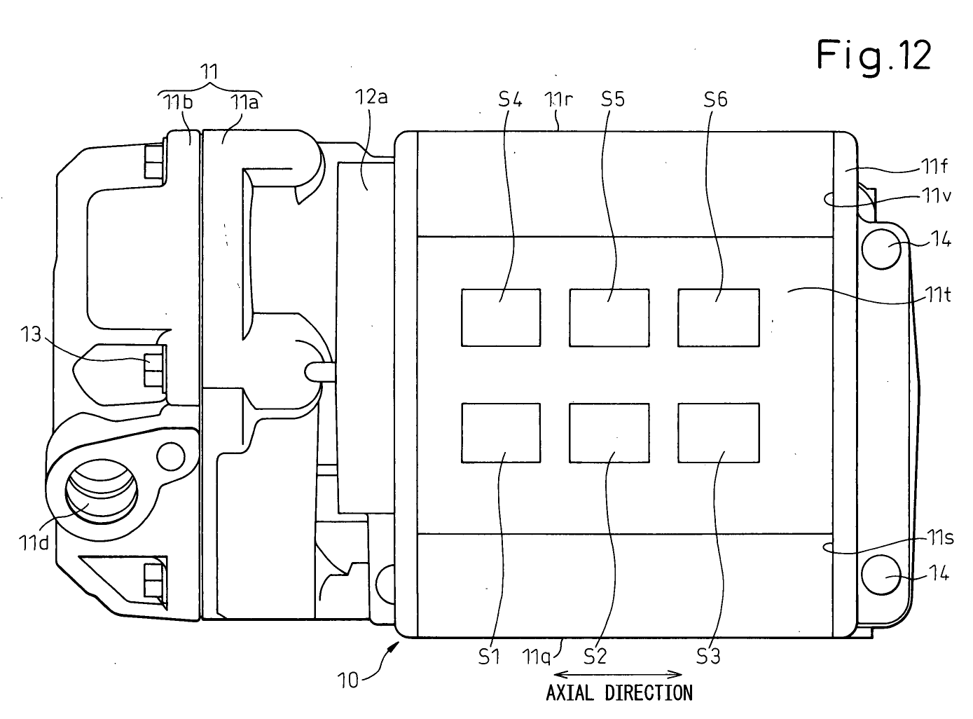

The first embodiment described above refers to a case in which the depressions 11s and 11v are formed by being depressed from the flat mounting portion 11t side. As an alternative, according to the present embodiment, the depressions 11s and 11v are formed as shown in FIGS. 11 and 12.

FIG. 11 is a sectional view showing the depressions 11s and 11v as viewed along the axial direction, and FIG. 12 a view showing the depressions 11s and 11v taken from above with the sub-communication circuit 50a, etc. not accommodated therein.

The depression 11s is formed at the corner formed by the side surface 11q making up the outer wall of the compressor housing 11 and the flat mounting portion 11t. The side surface 11q and the flat mounting portion 11t are formed orthogonally to each other. The depression 11s is depressed from the side surface 11q and the flat mounting portion 11t at the same time.

The depression 11v is formed at the corner formed by the side surface 11r making up the outer wall of the compressor housing 11 and the flat mounting portion 11t. The side surface 11r and the flat mounting portion 11t are formed orthogonally to each other. The depression 11v is depressed from the side surface 11r and the flat mounting portion 11t at the same time.

According to the present embodiment configured as described above, the electromagnetic coil 71a and the capacitor 71b accommodated in the depression 11s are covered by the housing body 200a from the side thereof (right side in FIG. 11).

The sub-communication circuit 50a accommodated in the depression 11v is covered by the housing body 200a from the side (right side in FIG. 11) thereof.

According to the embodiment described above, like in the first embodiment, the sub-communication circuit 50a is accommodated in the depression 11s, and therefore can be isolated from the electromagnetic noise generated from the semiconductor switching devices S1, S2, . . . , S6. Thus, the sub-communication circuit 50a is less affected by the electromagnetic noise.

### Fourth Embodiment

According to the first embodiment, the flat mounting portion 11t is arranged parallel to the axial direction of the compressor housing 11. On the other hand, according to the fourth embodiment, the flat mounting portion 11t is arranged orthogonally to the axial direction of the compressor housing 11.

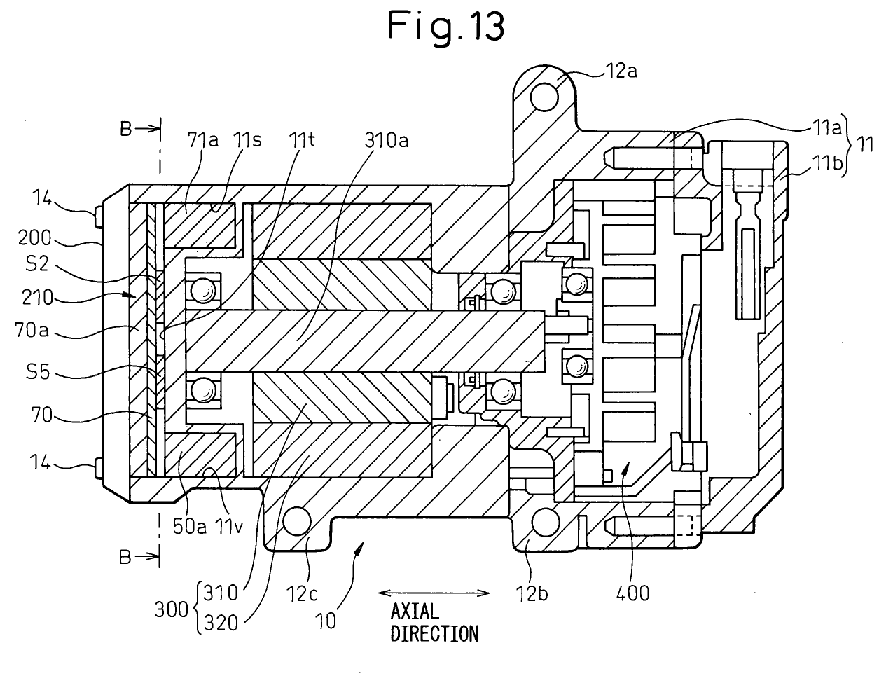

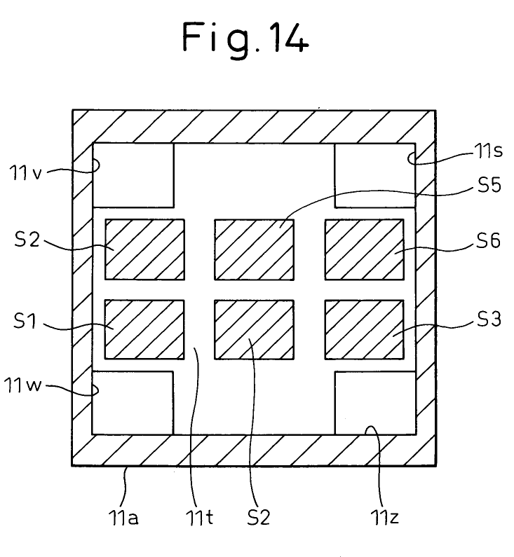

FIG. 13 is a sectional view showing the interior of the hollow portion of the compressor housing 11, and FIG. 14 a sectional view taken along line B-B in FIG. 13.

According to this embodiment, the flat mounting portion 11 is arranged at an axial position of the compressor housing 11 far from the compression unit 400. The flat mounting portion 11t is formed orthogonally to the axial direction of the compressor housing 11. The semiconductor switching devices S1, S2, . . . , S6 are mounted on the flat mounting portion 11t.

The depressions 11s and 11v are formed on the upper side, in FIG. 14, of the flat mounting portion 11t as a part of the solid portion of the compressor housing 11. The depressions 11s and 11v are arranged in horizontally spaced relation with each other in FIG. 14. The sub-communication circuit 50a is accommodated in the depression 11v, and the electromagnetic coil 71a and the capacitor 71b in the depression 11s.

The depressions 11w and 11z are formed on the lower side, in FIG. 14, of the flat mounting portion 11t as a part of the solid portion of the compressor housing 11. The depressions 11w and 11z are arranged in horizontally spaced relation with each other in FIG. 14. The signal processing circuit 51a is accommodated in the depression 11w, and the arithmetic circuit 51b in the depression 11z.

The encompassing wall portion 11f is formed in such a manner as to surround the flat mounting portion 11 and the depressions 11s, 11v, 11w and 11z.

The motor drive circuit 210 configured of the semiconductor switching devices S1, S2, . . . , S6 and the circuit board 70 is accommodated inside the encompassing wall portion 11f. The opening formed by the encompassing wall portion 11f is closed by the motor drive housing 200.

According to the embodiment described above, the signal processing circuit 51a is accommodated in the depression 11w together with the sub-communication circuit 50a, and the arithmetic circuit 51b is accommodated in the depression 11z. Therefore, the signal processing circuit 51a and arithmetic circuit 51b can be isolated from the electromagnetic noise generated by the semiconductor switching devices S1 to S6. As a result, the signal processing circuit 51a and the arithmetic circuit 51b are not easily affected by the electromagnetic noise.

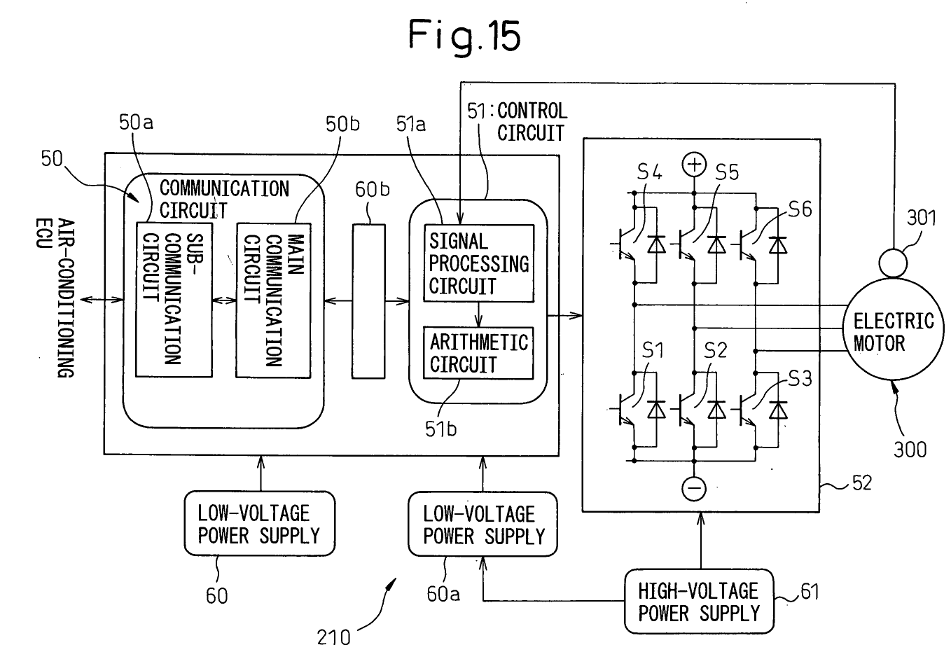

According to the first embodiment described above, a case is described in which a battery for outputting a low output voltage from the high-voltage power supply 61 is used as the low-voltage power supply 63. As an alternative, as shown in FIG. 15, a voltage-drop circuit for outputting a low output voltage from the high-voltage power supply 61 may be used as the low-voltage power supply 60a.

In the case of FIG. 15, the low-voltage power supply 60a supplies power to the control circuit 51 separately from the low-voltage power supply 60. The low-voltage power supply 60 is for supplying power to the communication circuit 50. A photocoupler 60b is inserted between the control circuit 51 and the communication circuit 50. Signals are input and output between the control circuit 51 and the communication circuit 50 through the photocoupler 60b. The photocoupler 60b electrically insulates the control circuit 51 and the communication circuit 50 from each other.

The first embodiment described above represents a case in which the rotation sensor 301 is used for detecting the speed of the electric motor 300. As an alternative, a current sensor may be used which detects the three-phase AC current flowing in the stator coil of the stator 320 from the switching circuit 52. In this case, the signal processing circuit 51a estimates the speed of the electric motor 300 based on the three-phase AC current detected by the sensor.

The optical encoder may be used as the rotation sensor 300.

The first embodiment described above concerns a case in which the depressions 11s and 11v are formed in such a manner as to open outward of the compressor housing 11. As an alternative, the depressions 11s and 11v may be formed in such a manner as to open toward the hollow portion of the compressor housing 11.

The first embodiment described above concerns a case in which the depressions 11s and 11v are formed on the compressor housing 11. However, this invention is not limited to this configuration, and only the depression 11v for accommodating the sub-communication circuit 50a may be arranged on the solid portion of the compressor housing 11.

The first embodiment described above concerns a case in which the semiconductor switching devices S1, S2, . . . , S6 are arranged on the flat mounting portion 11t. However, this invention is not limited to this configuration, and the semiconductor switching devices S1, S2, . . . , S6 may be arranged anywhere outside the depression 11v for accommodating the sub-communication circuit 50a.

The first embodiment described above concerns a case in which the sub-communication circuit 50a is accommodated in the depression of the compressor housing 11 as a part of the low-voltage circuit. However, this invention is not limited to this configuration and the whole low-voltage circuit may be accommodated in the depression of the compressor housing 11.

The first embodiment described above concerns a case in which the high-voltage circuit 52 according to the invention is configured using the six semiconductor switching devices S1, S2, . . . , S6. However, this invention is not limited to this configuration, and any other configuration may be employed as long as the drive voltage for the electric motor 300 is output based on the output voltage of the high-voltage power supply 61 by the switching operation of the semiconductor switching devices.

The first embodiment described above concerns a case in which the synchronous three-phase AC motor is used as the electric motor 300. However, this invention may alternatively employ any electric motor.

The first embodiment described above concerns a case in which the low-voltage circuit according to the invention includes the communication circuit 50 and the control circuit 51. As long as the electric motor 300 is controlled regardless of the air-conditioning ECU, however, any configuration may alternatively be employed in which the low-voltage circuit has no communication circuit 50 and the electric motor 300 is controlled only by the control circuit 51.

The first embodiment described above concerns a case in which bipolar transistors of insulated gate type are used as the semiconductor switching devices S1, S2, . . . , S6. Nevertheless, this invention is not limited to such a configuration and any of the various semiconductor switching devices may be used.

The first embodiment described above concerns a case in which the sub-communication circuit 50a of the low-voltage circuit is accommodated in the depression 11v of the compressor housing 11. However, this invention is not limited to this configuration, but the whole low-voltage circuit may be accommodated in the depression 11v of the compressor housing 11.

The first embodiment described above concerns a case in which the mounting structure of the motor drive circuit according to the invention is used with the automotive air conditioning system. However, as an alternative, the mounting structure of the motor drive circuit may be used with any type of apparatuses other than the electric compressor

While the invention has been described by reference to specific embodiments chosen for purposes of illustration, it should be apparent that numerous modifications could be made thereto by those skilled in the art without departing from the basic concept and scope of the invention.

1. A mounting structure of a motor drive circuit, comprising:
a metal housing;
an electric motor arranged in a hollow portion of the housing; and
a motor drive circuit for driving the electric motor, the motor drive circuit being mounted on the outside of the housing and including:
a high-voltage circuit having switching devices adapted to output, by a switching operation thereof, the drive voltage for the electric motor based on the output voltage of a high-voltage power supply; and
a low-voltage circuit supplied with power from a low-voltage power supply for outputting a source voltage lower than the output voltage of the high-voltage power supply thereby to cause the switching devices to perform the switching operation,
wherein a depression is formed on a solid portion of the housing, and
wherein the low-voltage circuit is arranged in the depression while the switching devices are arranged outside the depression.

2. The mounting structure of a motor drive circuit according to claim 1,
wherein the low-voltage circuit includes a communication circuit for conducting communication with an external device and a control circuit for outputting a control signal to control the switching operation of the switching devices based on the communication between the external device and the communication circuit, and
wherein the communication circuit is arranged in the depression.

3. The mounting structure of a motor drive circuit according to claim 1 further comprising a sensor for detecting a rotational speed information indicating the speed of the electric motor,
wherein the speed of the electric motor is changed with the drive voltage output from the high-voltage circuit,
wherein the low-voltage circuit includes a control circuit for operating the switching devices in such a manner that the drive voltage for attaining the actual speed of the electric motor in proximity to the target speed of the electric motor is output from the high-voltage circuit based on the detection value of the sensor, and
wherein the control circuit is arranged in the depression.

4. The mounting structure of a motor drive circuit according to claim 3,
wherein the control circuit includes a signal processing circuit for processing the output signal of the sensor and an arithmetic circuit for outputting a control signal to control the switching operation of the switching devices based on an output signal of the signal processing circuit, and
wherein one of the signal processing circuit and the arithmetic circuit is arranged in the depression.

5. The mounting structure of a motor drive circuit according to claim 1,
wherein the housing is formed substantially in the shape of a cylinder,
wherein the outer wall of the housing has a first surface formed in superposition with a longitudinal axis of the housing and the switching devices are mounted on the first surface, and
wherein the depression formed on the solid portion of the housing is located lateral to the first surface.

6. The mounting structure of a motor drive circuit according to claim 1,
wherein the housing is formed substantially in the shape of a cylinder,
wherein the electric motor includes a rotary shaft arranged in the hollow portion of the housing in such a manner as to extend in a direction of a longitudinal axis of the housing, a rotor arranged in the hollow portion of the housing to rotate the rotary shaft based on a rotating magnetic field, and a stator arranged radially outward in relation to the rotor in the hollow portion of the housing to generate the rotating magnetic field based on the output voltage of the high-voltage circuit, and
wherein the depression formed on the solid portion of the housing is located on one side of the stator in the axial direction.

7. The mounting structure of a motor drive circuit according to claim 1,
wherein the housing is formed in the shape of a cylinder, and
wherein the depression formed on the solid portion of the housing is located along the longitudinal axis of the housing.

8. The mounting structure of a motor drive circuit according to claim 5,
wherein the outer wall of the housing has a second surface crossing the first surface, and
wherein the depression is formed at the corner of the first and second surfaces in such a manner as to be depressed from both the first surface side and the second surface side.

9. The mounting structure of a motor drive circuit according to claim 1 further comprising a compression unit arranged in the hollow portion of the housing and driven by the electric motor,
wherein the housing is provided with a refrigerant inlet and a refrigerant-outlet, and
wherein the compression unit sucks in the refrigerant through the refrigerant inlet to compress it and discharges a high-pressure refrigerant from the refrigerant outlet.

10. An electric compressor comprising:
a metal housing having a refrigerant inlet and a refrigerant outlet;
a compression unit arranged in a hollow portion of the housing for sucking in the refrigerant through the refrigerant inlet, compressing it and discharging a high-pressure refrigerant from the refrigerant outlet;
an electric motor arranged in the hollow portion of the housing to drive the compression unit; and
a motor drive circuit for driving the electric motor, the motor drive circuit being mounted on the outside of the housing and including:
a high-voltage circuit having switching devices adapted to output, by a switching operation thereof, the drive voltage for the electric motor based on the output voltage of a high-voltage power supply; and
a low-voltage circuit supplied with power from a low-voltage power supply to cause the switching devices to perform a switching operation,
wherein an open depression is formed on a solid portion of the housing, and at least a part of the low-voltage circuit is arranged in the depression while the switching devices are arranged outside the depression.
